(19) United States
(12) Patent Application Publication
(10) Pub. No.: US 2006/0279702 A1
(43) Pub. Date: Dec. 14, 2006

(54) Projection assembly

(76) Inventors: Wiatt E. Kettle, Corvallis, OR (US); Scott Lerner, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/149,633

(22) Filed: Jun. 9, 2005

(51) Int. Cl. G03B 21/14

(52) U.S. Cl. 353/20

(57) ABSTRACT

A projection assembly including a light modulator assembly that includes a dichroic beam splitter, including first and second dichroic surfaces, the dichroic surfaces being crossed relative to one another, and first, second, and third light modulator panels in optical communication with the dichroic beam splitter, and a wobbling polarized plate at an optical pupil of said light modulator assembly in optical communication with the light modulator assembly.

### BACKGROUND

A conventional system or device for displaying an image, such as a display, projector, or other imaging system, is frequently used to display a still or video image. Viewers evaluate display systems based on many criteria such as image size, contrast ratio, color purity, brightness, pixel color accuracy, and resolution. Image brightness, pixel color accuracy, and resolution are particularly important metrics in many display markets because the available brightness, pixel color accuracy, and resolution can limit the size of a displayed image and control how well the image can be seen in venues having high levels of ambient light.

A conventional display system produces a displayed image by addressing an array of pixels arranged in horizontal rows and vertical columns. Because pixels have a rectangular shape, it can be difficult to represent a diagonal or curved edge of an object in an image that is to be displayed without giving that edge a stair-stepped or jagged appearance. Furthermore, if one or more of the pixels of the display system is defective, the displayed image will be affected by the defect. For example, if a pixel of the display system exhibits only an “off” position, the pixel may produce a solid black square in the displayed image. The undesirable results of pixel geometry and pixel inaccuracy are accentuated when the displayed image is projected onto a large viewing surface in color.

### SUMMARY

A projection assembly including a light modulator assembly that includes a dichroic beam splitter, including first and second dichroic surfaces, the dichroic surfaces being crossed relative to one another, and first, second, and third light modulator panels in optical communication with the dichroic beam splitter, and a wobbling polarized plate at an optical pupil of said light modulator assembly in optical communication with the light modulator assembly.

### BRIEF DESCRIPTION OF THE DRAWINGS

The accompanying drawings illustrate various embodiments of the present apparatus and method and are a part of the specification. The illustrated embodiments are merely examples of the present apparatus and method and do not limit the scope of the disclosure.

FIG. 1 illustrates a display system according to one exemplary embodiment.

FIG. 2 illustrates a light modulator assembly that includes a dichroic cube according to one exemplary embodiment.

FIG. 3 illustrates an on-axis projection assembly according to one exemplary embodiment.

FIG. 4 illustrates a sub-frame at a first location according to one exemplary embodiment.

FIG. 5 illustrates a sub-frame at a second location according to one exemplary embodiment.

FIG. 6 illustrates sub-frames at first and second locations according to one exemplary embodiment.

Throughout the drawings, identical reference numbers designate similar, but not necessarily identical, elements.

### DETAILED DESCRIPTION

A projection assembly is provided herein for use with projection assemblies and display systems such as televisions, projectors, etc. According to an exemplary embodiment, the projection assembly includes a wobbling directing member that directs multi-component light from crossed dichroic surfaces. The crossed dichroic surfaces are configured to split multi-component light into several components and direct each component to a corresponding light modulator panel. Each light modulator panel modulates the component light to form a sub-image. The sub-images are then directed back through the dichroic beam splitter and to the wobbling directing member. The wobbling directing member selectively shifts the path of sub-images between the wobbling device and display optics to form images of relatively higher resolution than the native resolution of the modulator.

In the following description, for purposes of explanation, numerous specific details are set forth in order to provide a thorough understanding of the present method and apparatus. It will be apparent, however, to one skilled in the art, that the present method and apparatus may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

Display System

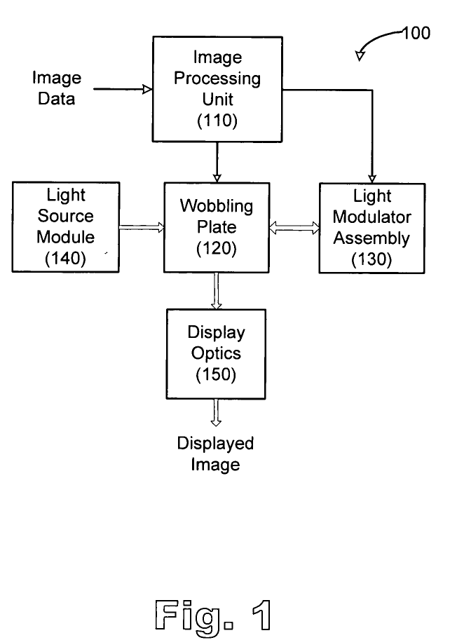

FIG. 1 illustrates an exemplary display system (100). The components of FIG. 1 are exemplary only and may be modified or changed as best serves a particular application. As shown in FIG. 1, image data is input into an image processing unit (110). The image data defines an image that is to be displayed by the display system (100).

While one image is illustrated and described as being processed by the image processing unit (110), it will be understood by one skilled in the art that a plurality or series of images may be processed by the image processing unit (110). The image processing unit (110) performs various functions including controlling the operation of a wobbling plate (120) and controlling a spatial light modulator (SLM) assembly (130).

The display system (100) also includes a light source module (140). The light source module (140) generates multi-component light and directs the multi-component light through the wobbling plate (120) and to the SLM assembly (130). The terms “SLM” and “modulator” will be used interchangeably herein to refer to a spatial light modulator assembly. The incident light is split into individual components, such as red, green, and blue components. These components are then directed to corresponding modulator panels. The incident light may be modulated in its color, frequency, phase, intensity, polarization, or direction by the modulator panels. The SLM assembly (130) includes a plurality of individual light modulator panels that are in optical communication with a dichroic beam splitter.

For example, according to one exemplary embodiment, the SLM assembly (130) includes crossed dichroic surfaces that split the white light directed to the SLM assembly (130) from the light source module (140) into component beams, and then direct the component beams, such as a red beam, a blue beam, and a green beam, to corresponding light modulator panels. Further, according to an exemplary embodiment discussed below, the crossed dichroic surfaces may be formed on a dichroic cube or a dichroic cube. The modulated light is then directed from the dichroic cube or cube back to the wobbling plate (120).

The wobbling plate (120) then spatially shifts the path of the modulated light between the wobbling plate (120) and the display optics (150). By selectively shifting the path of the modulated light with the wobbling plate (120), the display system is able to produce images of relatively high resolution compared to images produced by systems without a wobbling plate (120). The spatially shifting modulated light is then focused on a display surface by the display optics (150) to form a displayed image.

The display optics (150) may include any device configured to display or project an image. For example, the display optics (150) may be, but are not limited to, a lens configured to project and focus an image onto a viewing surface. The viewing surface may be, but is not limited to, a screen, television such as a rear projection type television, wall, liquid crystal display (LCD), or computer monitor. An exemplary method of modulating light in a spatial light modulator will now be discussed.

Light Modulator Assembly Having a Dichroic Cube

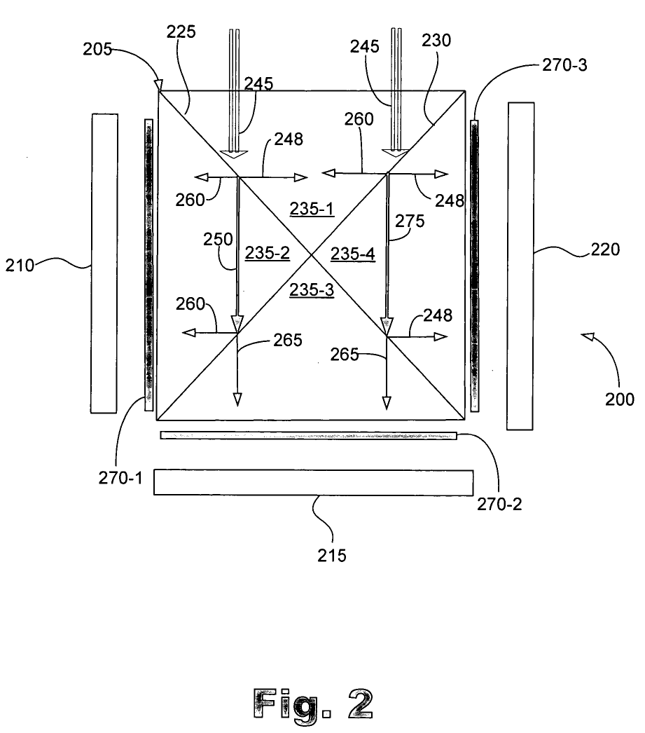

FIG. 2 illustrates an exemplary light modulator assembly (200). The light modulator assembly (200) includes a dichroic cube (205), a blue modulator panel (210), a green modulator panel (215), and a red modulator panel (220). While a red, blue, green configuration is described, those of skill in the art will appreciate that other configurations are possible.

Accordingly, the present exemplary light modulator assembly (200) is a three-panel type light modulator assembly. As will be discussed in more detail below, the dichroic cube (205) splits light into its component colors and directs each component color to an associated modulator.

The dichroic cube (205) includes a first dichroic surface (225) and a second dichroic surface (230). In particular, according to the present exemplary embodiment, the first dichroic surface (225) and second dichroic surface (230) are formed on first, second, third, and fourth prisms (235-1, 235-2, 235-3, 2354). The resulting first and second dichroic surfaces (225, 230) form a cross.

The first dichroic surface (225), according to the first exemplary embodiment, is configured to transmit green and blue light and to reflect red light. In particular, the first dichroic surface (225) may include a dichroic layer formed on glass or other suitable transparent or semi-transparent material as is well known in the art.

The second dichroic surface (230) is configured to transmit red and green light and to reflect blue light. In particular, the second dichroic surface (230) may include a dichroic layer formed on glass or other suitable transparent or semi-transparent material.

White light (245) is directed to the light modulator assembly (200) from a light source module (140; FIG. 1) and enters the first prism (235-1) where it is incident on the first and second dichroic surfaces (225, 230). That portion of white light (245) incident on the first dichroic surface (225) is split into two beams. The red component beam (248) is reflected away from the first dichroic surface (225) with a substantially similar angle of reflection, while a green/blue beam (250) is transmitted to the second prism (235-2).

The blue/green beam (250) is directed through the second prism (235-2) until it is incident on the second dichroic surface (230). As introduced, the second dichroic surface (230) is configured to transmit green and red light and to reflect blue light. Consequently, the second dichroic surface (230) splits the blue/green beam (250) into a blue beam (260), which is reflected, and a green beam (265), which is passed into the third prism (235-3).

The reflected blue beam (260) is directed to the blue modulator panel (210), while the transmitted green beam (265) is directed to the green modulator panel (215). According to the present exemplary embodiment, an optional blue filter (270-1) is placed between the dichroic cube (205) and the blue modulator panel (210), and an optional green filter (270-2) is placed between the dichroic cube (205) and the green modulator panel (215). The filters (270-1, 270-2) reduce the amount of stray light directed to each modulator panel. Accordingly, the blue and green portions of white light (245) incident on the first dichroic surface (225) are split and directed to the blue and green modulator panels (210, 215) respectively.

The red portion (248) of white light (245) incident on the first dichroic surface (225) of the first prism (235-1) is reflected away therefrom. In particular, the reflected red beam (248) is directed through the first prism (235-1) to the second dichroic surface (230). The second dichroic surface (230) transmits the red beam (248) and directs it to the red modulator panel (220). According to the present exemplary embodiment, an optional red filter (270-3) is placed between the dichroic cube (205) and the red modulator panel (220). The red filter (270-3) minimizes stray or non-red light that reaches the red modulator panel (220).

The second dichroic surface (230) is also configured to split white light (245) that is incident thereon in the first prism (235-1). In particular, when white light (245) is directed to the second dichroic surface (230) of the first prism (235-1) a red/green beam (275) is transmitted to the fourth prism (235-4) while a blue beam (260) is reflected.

The reflected blue beam (260) is directed across the first prism (235-1) to the first dichroic surface (225). The first dichroic surface (225) transmits the blue beam (260) through the second prism (235-2) to the blue modulator panel (210).

The red/green beam (275) from the first prism (235-1) is directed to the first dichroic surface (225) in the fourth prism (235-4). This red/green beam (275) is then split into two beams. One beam includes a reflected red beam (248), which is directed through the red filter (270-3) to the red modulator panel (220). The second beam includes a transmitted green beam (265), which is directed through the third prism (235-3) and the green filter (270-2) to the green modulator panel (215).

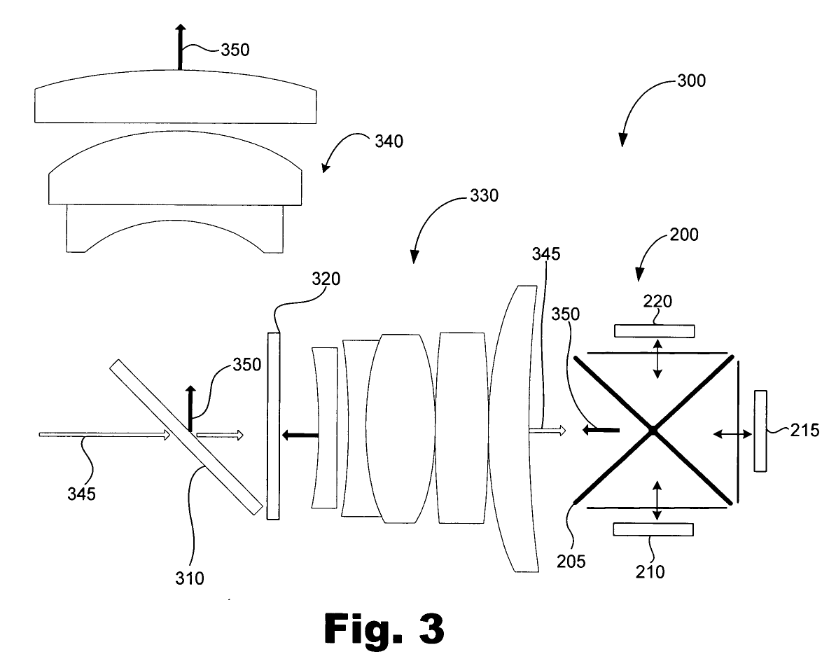

The light directed to red, green, and blue modulator panels (210, 215, 220) is then modulated to form individual sub-images. An exemplary projection assembly that includes a wobbling polarized plate (300; FIG. 3) will now be discussed in more detail.

On-Axis Projection Assembly

FIG. 3 illustrates an on-axis projection assembly (300). The projection assembly (300) includes a directing member such as a wobbling polarized plate (310), a ¼ wave plate (320), a light modulator assembly (200) including a dichroic cube (205), a coupling lens assembly (330), and display optics (340). As will be discussed in more detail below, the on-axis projection assembly (300) uses polarization in an on-axis configuration to direct light to and from the light modulator assembly (200).

As seen in FIG. 3, linearly polarized white light (345) with an initial polarization and orientation is directed to the wobbling polarized plate (310). The wobbling polarized plate (310) is configured to transmit the type of polarized white light directed thereto toward the light modulator panel assembly (200). Additionally, the wobbling polarized plate (310) is located at or near the optical pupil of the projection assembly (300). Such a location may allow the wobbling polarized plate (310) to direct light from a light source to the light modulator assembly (200) and to increase the resolution of images produced by the light modulator assembly (200) by selectively shifting the output of the light modulator assembly to display optics, as will be discussed in more detail below. By using the wobbling polarized plate to transmit light to the light modulator assembly and for shifting the path of modulated light, relatively fewer parts may be used.

Thereafter, according to the present exemplary embodiment, as the polarized white light (345) is directed toward the light modulator assembly (200), it passes through the ¼ wave plate (320) and the coupling lens assembly (330). The ¼ wave plate changes the polarization of the linearly polarized light to circularly polarized.

After the polarized white light (345) is passed initially through the ¼ wave plate (320), the polarized white light (345) is directed to the coupling lens assembly (330). The coupling lens assembly (330) focuses it onto the light modulator assembly (200). The light modulator assembly splits the polarized white light (345) and directs the component beams onto the red, green, and blue modulator panels (210, 215, 220).

The modulated component beams are then returned along substantially the same paths as taken to the modulator panels. This modulated light exits the light modulator assembly (200) and is directed to the coupling lens assembly (330). The coupling lens assembly (330) collimates and combines the output of each of the modulator panels (210, 215, 220) exiting the light modulator assembly (200) into a modulated light beam (350) and directs the modulated light beam (350) to the ¼ wave plate (320).

As the modulated light (350) passes through the ¼ wave plate (320), the polarization of modulated light is again rotated, such that the modulated light (350) has a polarization that is orthogonal to that of the linearly polarized white light (345).

This orthogonal polarized modulated light is then directed to the wobbling polarized plate (310). As previously discussed, the wobbling polarized plate (310) is configured to reflect light having the polarization and orientation of the light initially directed thereto. In addition, the wobbling polarized plate (310) is configured to transmit light having an orthogonal orientation. As discussed, the ¼ wave plate (320) rotates the polarization of the modulated light, such that it is orthogonal that of the entering polarized white light (345).

Accordingly, in addition to transmitting light from a light source module to the light modulator assembly, the wobbling polarized plate (310) reflects the modulated light to the display optics assembly (340). The display optics assembly (340) directs the modulated light onto a display surface to form a full-color image thereon. In addition, the location of the wobbling polarized plate (310) at or near the optical pupil of the projection assembly (200) allows the wobbling polarized plate also to selectively shift the path of modulated light to thereby increase the resolution of the projected image relative to the native resolution of the light modulator assembly (200).

More specifically, as introduced, the wobbling polarized plate (310) also has wobulator control coupled thereto. Wobulator control, or wobulation, refers to a process of shifting the position of a light path relative to the wobbling polarized plate (310). In other words, the imaging processing unit (110; FIG. 1) shifts the position of the wobbling polarized plate (310) such that each light from each pixel of each of the modulator panels is displayed in a slightly different spatial position. This concept is discussed in United Stated Published Patent Application 20040028293 filed Aug. 7, 2002, which is hereby incorporated by reference in its entirety.

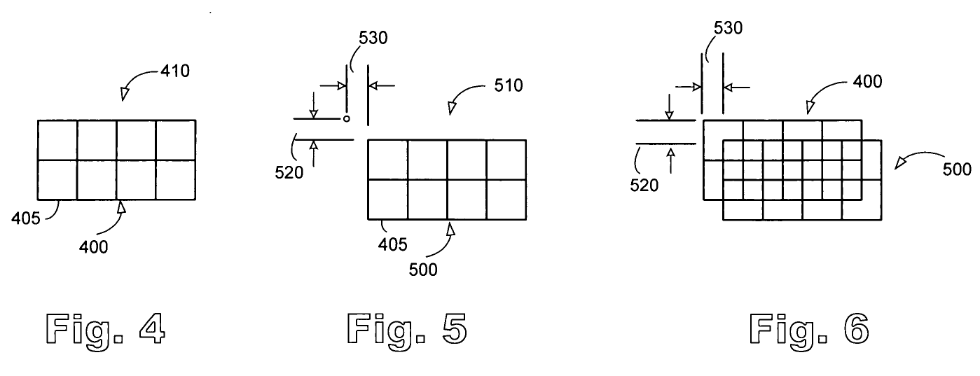

FIGS. 4-6 illustrate an exemplary embodiment wherein a number of image sub-frames are generated for a particular image. As illustrated in FIGS. 4-6, the exemplary image processing unit (110; FIG. 1) generates two image sub-frames for a particular image. More specifically, the image processing unit (110; FIG. 1) generates a first sub-frame (400) and a second sub-frame (500) for the image frame. The first sub-frame (400) and the second sub-frame (500) each comprise a data array of a subset of the image data for the corresponding image frame. In particular, the first and second sub-frames (400, 500) each include a plurality of pixels (405). Although the exemplary image processing unit (110; FIG. 1) generates two image sub-frames in the example of FIGS. 4-6, it will be understood that two image sub-frames are an exemplary number of image sub-frames that may be generated by the image processing unit (110; FIG. 1) and that any number of image sub-frames may be generated according to an exemplary embodiment.

In one embodiment, as illustrated in FIGS. 4-5, the first image sub-frame (400) is displayed in a first image sub-frame location (410). The second sub-frame (500) is displayed in a second image sub-frame location (510) that is offset from the first sub-frame location (410) by a vertical distance (520) and a horizontal distance (530). As such, the second sub-frame (500) is spatially offset from the first sub-frame (400) by a predetermined distance. In one illustrative embodiment, as shown in FIG. 6, the vertical distance (520) and horizontal distance (530) are each approximately one-half of one pixel. However, the spatial offset distance between the first image sub-frame location (410) and the second image sub-frame location (510) may vary as best serves a particular application. In alternative embodiments, the first sub-frame (400) and the second sub-frame (500) may only be offset in either the vertical direction or in the horizontal direction. In the illustrated embodiment, the wobbling polarized plate (310; FIG. 3) is configured to offset the beam of light between the wobbling polarized plate (310; FIG. 3) and the display optics (150; FIG. 1) such that the first and second sub-frames (400, 500; FIG. 6) are spatially offset from each other both vertically and horizontally.

As illustrated in FIG. 6, the wobbling polarized plate (310) is shifted between displaying the first sub-frame (400) in the first image sub-frame location (410) and displaying the second sub-frame (500) in the second image sub-frame location (510) that is spatially offset from the first image sub-frame location (410). As such, the pixels of the first sub-frame (400) overlap the pixels of the second sub-frame (500). In one embodiment, the display system (100; FIG. 1) completes one cycle of displaying the first sub-frame (400) in the first image sub-frame location (410) and displaying the second sub-frame (500) in the second image sub-frame location (510) resulting in a displayed image with an enhanced apparent resolution. Thus, the second sub-frame (500) is spatially and temporally displayed relative to the first sub-frame (400).

Thus, by generating a first and second sub-frame (400, 500) and displaying the two sub-frames in the spatially offset manner as illustrated in FIGS. 4-6, twice the amount of pixel data is used to create the finally displayed image as compared to the amount of pixel data used to create a finally displayed image without using the image sub-frames and wobulation. Accordingly, with two-position processing, the resolution of the finally displayed image is increased by a factor of approximately 1.4 or the square root of two.

In addition, the display system (100; FIG. 1) may be configured to provide four sub-frames and to shift the wobbling polarized plate (310; FIG. 3) to form the four sub-frames for an image frame. Thus, by generating four image sub-frames and displaying the four sub-frames in the spatially offset manner, four times the amount of pixel data is used to create the finally displayed image as compared to the amount of pixel data used to create a finally displayed image without using the image sub-frames. Accordingly, with four-position processing, the resolution of the finally displayed image is increased by a factor of two or the square root of four.

Thus, as shown by the examples in FIGS. 4-6, by generating a number of image sub-frames for an image frame and spatially and temporally displaying the image sub-frames relative to each other, the display system (100; FIG. 1) can produce a displayed image with a resolution greater than that which the SLM assembly (200; FIG. 2) is configured to display. In one illustrative embodiment, for example, with image data having a resolution of 800 pixels by 600 pixels and the SLM assembly (200; FIG. 2) having a resolution of 800 pixels by 600 pixels, four-position processing by the display system (100; FIG. 1) with resolution adjustment of the image data produces a displayed image with a resolution of 4000 pixels by 1200 pixels.

In addition, by overlapping pixels of image sub-frames, the display system (100; FIG. 1) may reduce the undesirable visual effects caused, for example, by a defective pixel. For example, if four sub-frames are generated and displayed in offset positions relative to each other, the four sub-frames effectively diffuse the undesirable effect of the defective pixel because a different portion of the image that is to be displayed is associated with the defective pixel in each sub-frame. A defective pixel is defined to include an aberrant or inoperative display pixel such as a pixel which exhibits only an “on” or “off” position, a pixel which produces less intensity or more intensity than intended, and/or a pixel with inconsistent or random operation.

In conclusion, a projection assembly has been discussed herein for use with projection assemblies and display systems such as televisions, projectors, etc. According to an exemplary embodiment, the projection assembly includes a wobbling directing member that directs multi-component light to crossed dichroic surfaces. The crossed dichroic surfaces are configured to split multi-component light into several components and direct each component to a corresponding light modulator panel. Each light modulator panel modulates the component light to form a sub-image. The sub-images are then directed back through the dichroic beam splitter and to the wobbling directing member. The wobbling directing member selectively shifts the path of sub-images between the wobbling device and display optics to form images of relatively high resolution.

The preceding description has been presented only to illustrate and describe the present method and apparatus. It is not intended to be exhaustive or to limit the disclosure to any precise form disclosed. Many modifications and variations are possible in light of the above teaching. It is intended that the scope of the disclosure be defined by the following claims.

What is claimed is:

1. A projection assembly, comprising:
a light modulator assembly that includes a dichroic beam splitter, including first and second dichroic surfaces, said dichroic surfaces being crossed relative to one another, and first, second, and third light modulator panels in optical communication with said dichroic beam splitter; and
a wobbling polarized plate at an optical pupil of said light modulator assembly in optical communication with said light modulator assembly.

2. The assembly of claim 1, and further comprising a coupling lens assembly in optical communication with said dichroic beam splitter, said coupling lens assembly being configured to collimate white light and focus said white light onto said dichroic beam splitter.

3. The assembly of claim 1, wherein said dichroic beam splitter comprises a dichroic cube.

4. The assembly of claim 1, wherein said wobbling polarized plate is configured to selectively pass light from a light source to said light modulator assembly and to direct modulated light from said light modulator assembly to display optics while selectively spatially shifting a path of said modulated light.

5. The assembly of claim 1, wherein said first dichroic surface is configured to reflect red light and to transmit blue and green light and said second dichroic surface is configured to reflect blue light and to transmit red and green light.

6. The assembly of claim 1, wherein said light modulator assembly and said wobbling polarized plate are configured to modulate light in an on-axis configuration.

7. The assembly of claim 1, and further comprising a first, second, and third filters placed between said first, second, and third modulator panels and said dichroic cross.

8. The assembly of claim 1, wherein first modulator panel includes a blue modulator panel, said second modulator panel includes a green modulator panel, and said third modulator panel includes a red modulator panel.

9. The assembly of claim 1, and further comprising a display optics assembly.

10. A display system, comprising:
a projection assembly including
a light modulator assembly including a dichroic beam splitter including first and second dichroic surfaces, said dichroic surfaces being crossed relative to one another, and first, second, and third light modulator panels,
a wobbling polarized plate in optical communication with said light modulator assembly; and
display optics in optical communication with said wobbling polarized plate; and
an image processing unit coupled to said light modulator assembly and said wobbling polarized plate, said image processing unit being configured to cause said light modulator assembly to form a plurality of sub-frames and to direct said wobbling polarized plate to direct said plurality of sub-frames to a plurality of locations.

11. The system of claim 10, and further comprising a light source module.

12. The system of claim 10, wherein said projection assembly is an on-axis projection assembly.

13. The system of claim 10, and further comprising a ¼ wave plate located at least partially between said light modulator assembly and said wobbling polarized plate.

14. A method of modulating light, comprising:
generating light;
passing said light through a wobbling polarized plate;
splitting said light into component beams;
modulating said component beams to form a plurality of sub-images, each sub-image including a plurality of sub-frames; and
selectively moving said wobbling polarized plate to selectively shift a path of said sub-frames.

15. The method of claim 14, wherein splitting said light includes passing said light through a dichroic beam splitter.

16. The method of claim 14, wherein generating light includes generating linearly polarized light.

17. The method of claim 16, and further comprising passing said linearly polarized light through a ¼ wave plate and passing said sub-frames through said ¼ wave plate.

18. The method of claim 14, wherein selectively shifting a path of said sub-frames includes shifting said path of said sub-frames by approximately one-half pixel.

19. A system, comprising:
means for generating light;
means for splitting said light into component beams;
means for modulating said component beams; and
means for selectively shifting a path of said component beams, wherein said means for selectively shifting said path of said components is located at an optical pupil of said system.

20. The system of claim 19, and further comprising means for directing said component beams onto a display surface.

21. The system of claim 19, wherein said means for selectively shifting a path of said component beams includes a polarized plate.
